(19) United States
(12) Patent Application Publication
(10) Pub. No.: US 2026/0097524 A1
(43) Pub. Date: Apr. 9, 2026

(54) SYSTEM FOR HANDLING A COMPONENT OF A VEHICLE

(71) Applicant: Ford Global Technologies, LLC, Dearborn, MI (US)

(72) Inventors: Kurt Michael Lundeen, Novi, MI (US); Derrick Miller, Ypsilanti, MI (US); Jon Arthur Zimmerman, Ferndale, MI (US); Andrei Negrus, Prospect, KY (US); Zachary James Kadykowski, Chelsea, MI (US); John Randolf Vincent, Livonia, MI (US)

(73) Assignee: Ford Global Technologies, LLC, Dearborn, MI (US)

(21) Appl. No.: 18/909,210

(22) Filed: Oct. 8, 2024

(51) Int. Cl. B25J 15/00; B25J 9/16

(52) U.S. Cl. CPC B25J 15/0038; B25J 9/16

(57) ABSTRACT

A system for handling a component of a vehicle includes a body, at least one protrusion, a robot, and a gripper structure. The body is configured to house electrical components and defines a longitudinal axis. The protrusion extends outwardly from the body along an axis. The protrusion includes a cylindrical shaped inner portion at a proximal end of the protrusion and a tapered outer portion near a distal end of the protrusion. The robot is configured to move the body. The gripper structure is secured to the robot and includes at least one mounting feature. The mounting feature includes a portion comprising a shape that corresponds to the cylindrical shaped inner portion of the protrusion such that the gripper structure is configured to be removably coupled to the component.

### FIELD

The present disclosure relates to a system for handling a component of a vehicle.

### BACKGROUND

The statements in this section merely provide background information related to the present disclosure and may not constitute prior art.

Industrial robots have been used for a variety of manufacturing operations, including by way of example, welding, placement of parts for subsequent fabrication or assembly operations, and moving parts from one location to another such as retrieving parts from a storage location and moving them to an assembly station. Automating the moving of some vehicle parts such as wire harnesses, for example, may be challenging because of the lack of proper handling of the part and mechanical repeatability.

These issues related to automating the handling of components, among other issues related to processing the components, are addressed by the present disclosure.

### SUMMARY

This section provides a general summary of the disclosure and is not a comprehensive disclosure of its full scope or all of its features.

In one form, the present disclosure provides a system for handling electrical components of a vehicle. The system includes a body, at least one first protrusion, a robot, and a gripper structure. The body is configured to house the electrical components and defines a longitudinal axis. The first protrusion extends outwardly from the body along an axis. The first protrusion includes a cylindrical shaped inner portion at a proximal end of the first protrusion and a tapered outer portion near a distal end of the first protrusion. The robot configured to move the body. The gripper structure secured to the robot and includes at least one first mounting feature. The first mounting feature includes a portion including a shape that corresponds to the cylindrical shaped inner portion of the first protrusion such that the gripper structure is configured to be removably coupled to the body.

In variations of the system of the above paragraph, which can be implemented individually or in any combination: the first protrusion includes a circular periphery at the distal end, a diameter of the circular periphery is greater than a diameter of the cylindrical portion; the first protrusion includes a circular periphery at the distal end, the first protrusion tapers from the circular periphery towards the cylindrical portion; the first mounting feature is an aperture, the first protrusion extends through the aperture; the aperture is arcuate; the first protrusion has a funnel shape; the system further includes a second protrusion extending outwardly from the body and a third protrusion spaced apart from the second protrusion and extending outwardly from the body; the system further includes a first mounting plate configured to be secured to a stationary body and including a second mounting feature configured to receive the second protrusion, the second mounting feature having a first upper portion and a first lower portion, the first upper portion having a diameter than is greater than a width of the first lower portion; the system further includes a second mounting plate spaced apart from the first mounting plate and configured to be secured to the stationary body, the second mounting plate including a third mounting feature configured to receive the third protrusion, the third mounting feature having a second upper portion and a second lower portion, the second upper portion having a diameter than is greater than a width of the second lower portion; a shape of the first lower portion is different than a shape of the second lower portion; the system further includes a controller configured to instruct the robot to move the body between a first position in which the body is decoupled from the stationary body and a second position in which the body is coupled to the stationary body, when the body is in the first position, the second and third protrusions are received in the first and second upper portions of the first and second mounting plates, respectively, and when the body is in the second position, the second and third protrusions are received in the first and second lower portions of the first and second mounting plates, respectively; and the axis of the first protrusion extends perpendicular to the longitudinal axis of the body.

In another form, the present disclosure provides a system for handling electrical components of a vehicle. The system includes a body, a pair of opposed first protrusions, a robot, and a gripper structure. The body is configured to house the electrical components and defines a longitudinal axis. The pair of opposed first protrusions extend outwardly from the body along an axis that is perpendicular to the longitudinal axis of the body. Each first protrusion of the pair of opposed first protrusions includes a proximal end, a distal end, and an outer surface. The outer surface is tapered from the proximal end towards the distal end. The robot is configured to move the body. The gripper structure is secured to the robot and includes a pair of opposed first mounting features. Each first mounting feature of the pair of opposed first mounting features includes a portion comprising a shape that corresponds to a portion of the outer surface of a respective first protrusion of the pair of opposed first protrusions such that the gripper structure is removably coupled to the body.

In variations of the system of the above paragraph, which can be implemented individually or in any combination: the system further includes a second protrusion extending outwardly from the body and a third protrusion spaced apart from the second protrusion and extending outwardly from the body, the pair of opposed first protrusions located between the second protrusion and the third protrusion; the system further includes a first mounting plate configured to be secured to a stationary body and including a second mounting feature configured to receive the second protrusion, the second mounting feature having a first upper portion and a first lower portion, the first upper portion having a diameter than is greater than a width of the first lower portion; and the system further includes a second mounting plate spaced apart from the first mounting plate and configured to be secured to the stationary body, the second mounting plate including a third mounting feature configured to receive the third protrusion, the third mounting feature having a second upper portion and a second lower portion, the second upper portion having a diameter than is greater than a width of the second lower portion; the system further includes a controller configured to instruct the robot to move the body between a first position in which the body is decoupled from the stationary body and a second position in which the body is coupled to the stationary body, when the body is in the first position, the second and third protrusions are received in the first and second upper portions of the first and second mounting plates, respectively, and when the body is in the second position, the second and third protrusions are received in the first and second lower portions of the first and second mounting plates, respectively; the gripping structure includes a pair of opposed plates, each plate of the pair of opposed plates includes a respective first mounting feature of the pair of opposed first mounting features; and the pair of opposed first mounting features are apertures formed in the pair of opposed plates.

In yet another form, the present disclosure provides a system for handling electrical components of a vehicle. The system includes a body, a robot, a gripper structure, and a pair of opposed mounting features. The body is configured to house the electrical components and defines a longitudinal axis. The robot is configured to move the body. The gripper structure is secured to the robot and includes a pair of opposed protrusions. Each protrusion of the pair of opposed protrusions extends from the body along an axis that is perpendicular to the longitudinal axis of the body. Each protrusion of the pair of opposed protrusions includes a proximal end, a distal end, and an outer surface. The outer surface is tapered from the proximal end towards the distal end. The pair of opposed mounting features associated with the body and configured to receive the pair of opposed protrusions such that the gripper structure is removably coupled to the body.

In variations of the system of the above paragraph, which can be implemented individually or in any combination: the pair of opposed mounting features are apertures formed in the body and the gripping structure includes a pair of opposed plates, each plate of the pair of opposed plates includes a respective protrusion of the pair of opposed protrusions.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1A is a perspective view of a system for handling components of a vehicle according to the principles of the present disclosure, the components being secured to a part support of the system;

FIG. 1B is a perspective view of a system for handling the components of a vehicle according to the principles of the present disclosure, one component of the components being placed on a work surface of the system;

FIG. 2 is a partial perspective of the components including collars secured to the part support of the system of FIGS. 1A and 1B;

FIG. 3A is a perspective view of a portion of the part support of the system of FIGS. 1A and 1B;

FIG. 3B is a perspective view of a portion of the part support of the system of FIGS. 1A and 1B;

FIGS. 4A-4C are front views of various mounting plates of the system of FIGS. 1A and 1B;

FIG. 5 is a perspective view of an end of one of the components with one collar secured thereto;

FIG. 6A is a side view of one of the collars of FIG. 2;

FIG. 6B is a top view of one of the collars of FIG. 2;

FIG. 7 is a perspective view of a robot of the system of FIG. 1 including a gripper apparatus according to the principles of the present disclosure;

FIG. 8 is a perspective view of the gripper apparatus of FIG. 7;

FIG. 9A is a side view of the gripper apparatus being secured to collars of the component;

FIG. 9B is a side view of the gripper apparatus secured to the collars of the component;

FIG. 9C is a top view of the gripper apparatus secured to the collars of the component;

FIG. 10 is a schematic block diagram showing components of the system of FIGS. 1A and 1B in accordance with the teachings of the present disclosure;

FIG. 11 is a flowchart depicting an algorithm for handling components of the system of FIGS. 1A and 1B in accordance with the teachings of the present disclosure;

FIG. 12 is a perspective view of a portion of the component including alternate collars secured thereto in accordance with the teachings of the present disclosure;

FIG. 13 is a perspective view of a portion of the component including alternate collars secured thereto in accordance with the teachings of the present disclosure;

FIG. 14 is a perspective view of a portion of another robot in accordance with the teachings of the present disclosure;

FIG. 15A is a perspective view of the robot of FIG. 14 disengaged from the component including the collars of FIG. 13;

FIG. 15B is a perspective view of the robot of FIG. 14 engaged with the component including the collars of FIG. 13;

FIG. 16 is a side view of one protrusion of one of the collars of FIG. 13;

FIG. 17 is a schematic block diagram showing components of the system including the robot of FIG. 14;

FIG. 18 is a flowchart depicting an algorithm for handling components of the system including the robot of FIG. 14 in accordance with the teachings of the present disclosure;

FIG. 19A is a perspective view of a portion of the component including alternate collars secured thereto in accordance with the teachings of the present disclosure;

FIG. 19B is a perspective view of a portion of the component including alternate collars secured thereto in accordance with the teachings of the present disclosure; and

FIG. 20 is a perspective view of a portion of another robot in accordance with the teachings of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

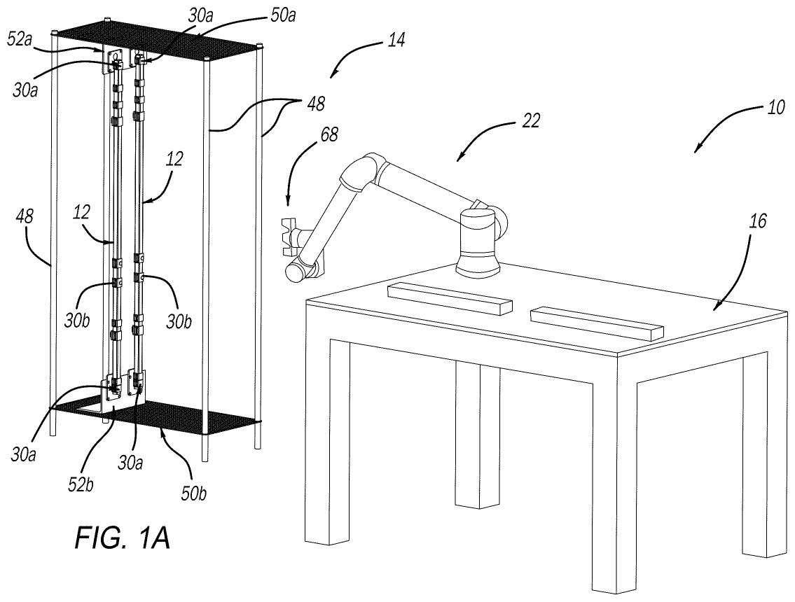

With reference to FIGS. 1A and 1B, a system 10 for handling vehicle components 12 is illustrated. The handling of the vehicle components 12 may include retrieving the vehicle components 12 from a part support 14 (e.g., a dunnage rack), manipulating the vehicle components 12, placing the vehicle components 12 onto a work surface 16, and/or installing the vehicle component 12 into a machine (e.g., a vehicle). The system 10 allows for the handling of the vehicle components 12 with little to no human intervention. In this way, the handling of the vehicle components 12 may be automated to increase productivity, reduce cycle time, and reduce variation and error, for example. In the example illustrated, the vehicle components 12 include electrical components such as wire harnesses. That is, wire harnesses tend to be flexible, complex, and highly variable from one part to the next, so that installation of the wire harness into the machine may be challenging to automate. The system 10 of the present disclosure provides for the adaptation of vehicle components 12 such as wire harnesses and the objects the vehicle components 12 interface with to better support automation. It should be understood that the vehicle components 12 may be other components of a vehicle other than wire harnesses.

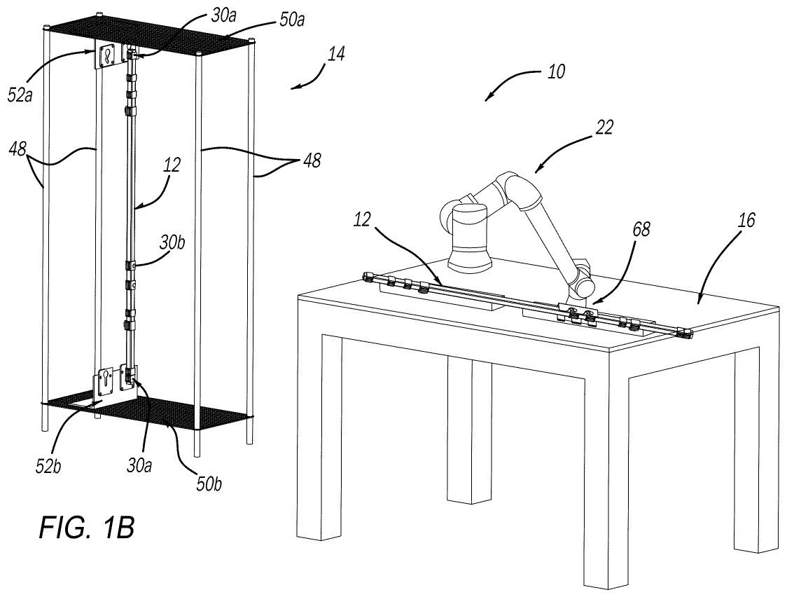

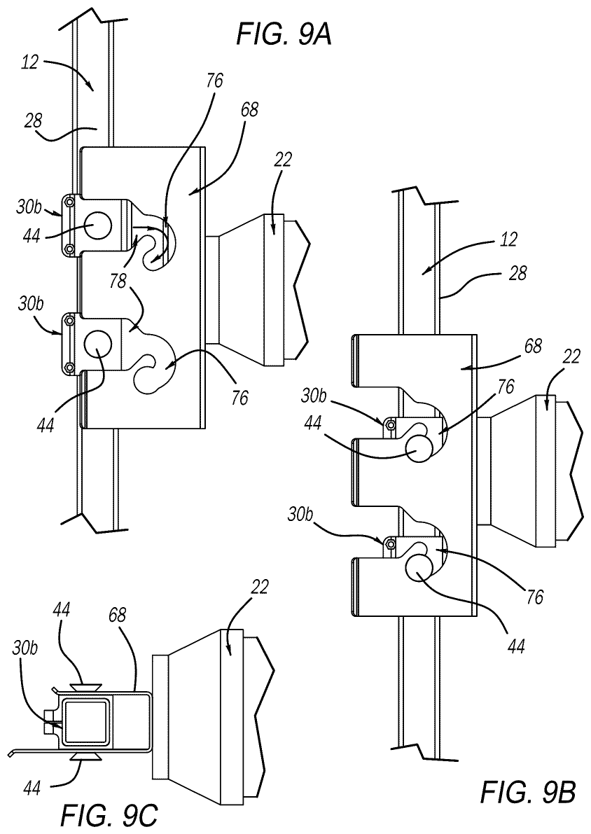

With reference to FIGS. 1A, 1B, and 2, the system 10 may include the vehicle components 12, the part support 14, one or more robots 22, and a controller 26 (FIG. 10). The vehicle components 12 may be moved from the part support 14 to the work surface 16 via the robots 22 as will be described in greater detail below. Each vehicle component 12 includes a body or housing 28 and a plurality of collars 30a, 30b. The body 28 may be made of a rigid material (e.g., metal or plastic) and may house electrical components (e.g., wires). In the example illustrated, the body 28 is hollow and has a square shape. In some forms, the body 28 may have a circular shape, rectangular shape, or any other suitable shape that may be house electrical components.

In the example illustrated, the collars 30a, 30b surround the body 28 and are secured to the body 28 via mechanical fasteners, adhesives, or any other suitable attachment means. With reference to FIGS. 2, 5, and 6A, the collars 30a are secured to respective ends 28a, 28b of the body 28 (i.e., the collars 30a are spaced apart from each other). Each collar 30a has a shape that corresponds to the shape of the body 28. In the example illustrated, the collar 30a has a square shape that corresponds to the square shape of the body 28. The collar 30a also has end portions defining apertures. Mechanical fasteners (not shown) may extend through the apertures of the end portions, thereby securing (e.g., clamping) the collar 30a onto the body 28.

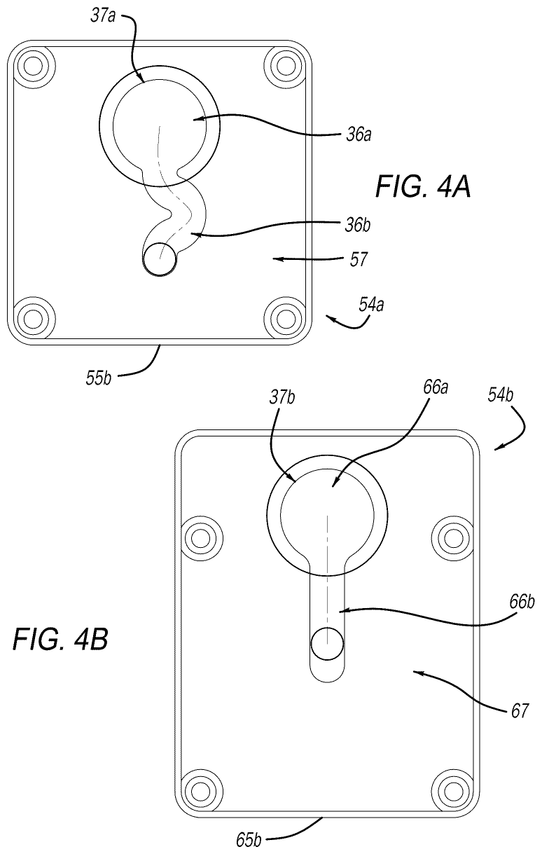

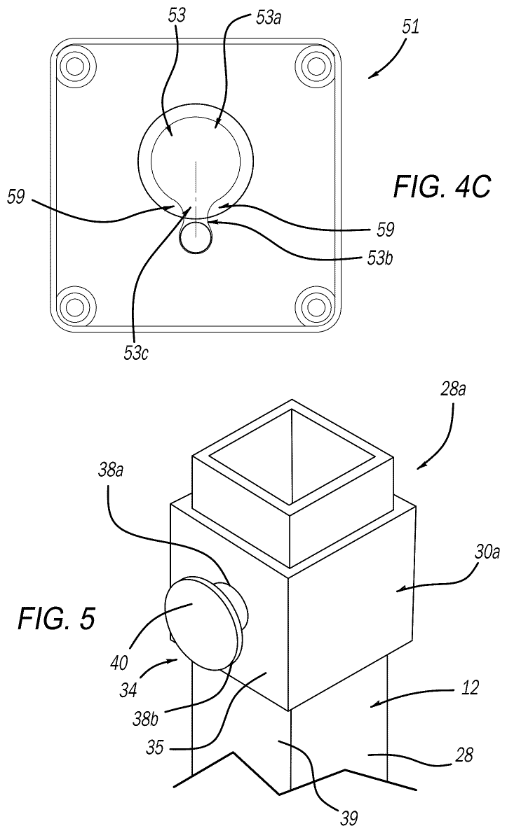

With reference to FIGS. 5, 6A and 6B, at least one protrusion 34 extends outward from a side 35 of the collar 30a and is configured to extend into a respective opening 37a, 37b of the part support 14, thereby coupling the vehicle component 12 to the part support 14. The protrusion 34 extends along an axis X1 that is perpendicular to an axis X2 of the body 28 and has a generally funnel shape. The protrusion 34 includes an inner portion 34a, an outer portion 34b, and a periphery 40. The inner portion 34a is located at or near a proximal end 38a of the protrusion 34 and has a cylindrical shape (i.e., an outer surface 25a of the inner portion 34a is cylindrical). The inner portion 34a is located about the axis X1 such that it surrounds or encircles the axis X1. The outer portion 34b is located at or near a distal end 38b of the protrusion 34 between the inner portion 34a and periphery 40. The outer portion 34b is tapered from the periphery 40 towards the inner portion 34a (i.e., an outer surface 25b of the outer portion 34b is angled) and is located about the axis X1. Stated differently, the outer portion 34b surrounds or encircles the axis X1 and has an outer surface 25b that extends radially outward relative to the axis X1 a further distance than the inner portion 34a. The periphery 40 has a circular shaped face having a diameter that is greater than a diameter of the cylindrical shaped inner portion 34a. The face faces away from the side 35 of the collar 30a and a side 39 of the body 28. When the protrusion 34 extends into the respective opening 37a, 37b of the part support 14, the inner portion 34a is received in the respective opening 37a, 37b. That is, the outer portion 34b is angled so as to facilitate positioning of the inner portion 34a into the respective opening 37a, 37b of the part support 14.

With reference to FIGS. 1A and 1B, the collars 30b are secured to the body 28 between the collars 30a and are configured to be coupled to a respective robot 22. In this way, the robot 22 may pick-up the vehicle component 12 and move it from the part support 14 to the work surface 16, for example, for further processing. Each collar 30b has a shape that corresponds to the shape of the body 28. In the example illustrated, the collar 30b has a square shape that corresponds to the square shape of the body 28. The collar 30b also has end portions defining apertures. Mechanical fasteners (not shown) may extend through the apertures of the end portions, thereby securing (e.g., clamping) the collar 30b onto the body 28.

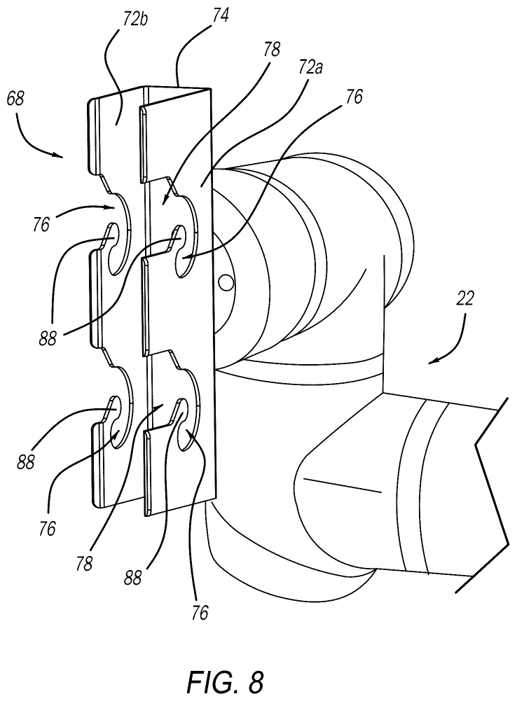

With reference to FIGS. 9A-9C, at least one protrusion 44 extends outward from a side of the collar 30b and is configured to extend into the mounting features 76, thereby coupling the vehicle component 12 to the robot 22. The structure and function of the protrusion 44 may be similar or identical to the protrusion 34 described above, and therefore, will not be described again in detail. Although the present disclosure shows the protrusions 34, 44 as being separate components from the body 28, in some forms, the body 28 may be manufactured (e.g., injection molding or 3D printing) to include the protrusions 34, 44. In this way, the body 28 may be a unitary, monolithic component including the protrusions 34, 44 for connecting to the part support 14 and robot 22, respectively. It should be understood that the vehicle components 12 may include additional collars/protrusions secured to the body 28 that allows for further processing of the vehicle components 12. One example of such collar is disclosed in Applicant's co-pending application titled “SYSTEM FOR HANDLING ELECTRICAL COMPONENTS” which is commonly owned with the present application and the contents of which are incorporated herein by reference in its entirety.

The part support 14 may disposed in an environment and may support the vehicle components 12 until the robots 22 move the vehicle components 12 from the part support 14 to the work surface 16 for further processing. In one form, a localization system (not shown) may be configured to localize the robots 22 to the part support 14 and/or the part support 14 relative to the robots 22. That is, the localization system is configured to convert a robot-based position of the robot 22 to a support-based position of the robot 22, a support-based position of the part support 14 to a robot-based position of the part support 14, or a combination thereof. As an example, the localization system may employ known imaging and fiducial marker systems that employ predefined robot/part support location coordinates and translation routines for localizing the robots 22 relative to the part support 14 and/or the part support 14 relative to the robots 22. As another example, the localization system may employ known object detection systems having predefined robot/part support location coordinates and translation routines for localizing the robots 22 relative to the part support 14 and/or the part support 14 relative to the robots 22, such as a localization structure.

With reference to FIGS. 1A and 1B, the part support 14 may be disposed at a known position using cones or guides located on a floor of an environment. In this way, the part support 14 may be moved horizontally or vertically into the known position using the cones or guides, thereby inhibiting the part support 14 from moving out of the known position when the robots 22 are moving the vehicle components 12 from the part support 14 to the work surface 16. In the example illustrated, the vehicle components 12 are coupled to the part support 14 so as to extend in a vertical direction. In this way, the robot 22 may grab a portion (e.g., a middle portion) of the body 28 of the vehicle component 12 to move the vehicle component 12 from the part support 14 to the work surface 16. In some forms, the vehicle components 12 are coupled to the part support 14 so as to extend in a horizontal direction. In this way, the robot 22 may grab a middle portion or a respective end 28a, 28b of the body 28 of the vehicle component 12 to move the vehicle component 12 from the part support 14 to the work surface 16.

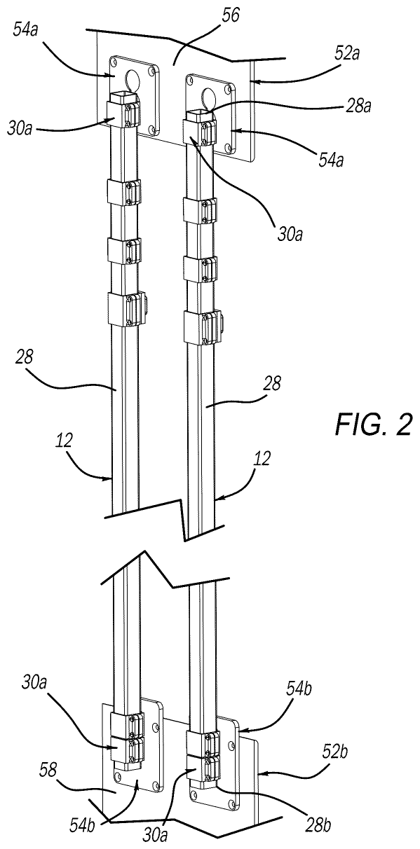

With reference to FIGS. 1A, 1B, 3A, 3B, 4A and 4B, the part support 14 includes a plurality of legs 48, an upper frame or rack 50a, a lower frame or rack 50b, upper brackets 52a (only one shown in the figures), lower brackets 52b (only one shown in the figures), and a plurality of mounting plates 54a, 54b. The legs 48 are disposed around a periphery of the part support 14 and may locate the part support 14 at a known position within the environment. The legs 48 may also support the upper frame 50a and the lower frame 50b and position the upper frame 50a and the lower frame 50b relative to each other. In the example illustrated, the legs 48 are positioned at respective corners of the part support 14. In some forms, the legs 48 may be positioned at a location between the corners of the part support 14, in addition to, or instead of, being position at respective corners.

The upper frame 50a is located at an upper end of the part support 14 and the lower frame 50b is located at a lower end of the part support 14. In some forms, the frames 50a, 50b may be removably coupled to the legs 48. In this way, the frames 50a, 50b may be adjustable along the lengths of the legs 48 so as to accommodate different sized vehicle components 12 supported on the part support 14. Each upper bracket 52a is coupled to the upper frame 50a and may also be secured to the vehicle components 12. In some forms, the upper bracket 52a may be removably coupled to the upper frame 50a so as to adjust the position of the upper bracket 52a relative to the upper frame 50a. In the example illustrated, the upper bracket 52a is an L-shaped bracket that includes a first member (not specifically shown) and a second member 56. The first member extends perpendicular to the second member 56 and is coupled to the upper frame 50a.

Each lower bracket 52b is coupled to the lower frame 50b and may also be secured to the vehicle components 12. In some forms, the lower bracket 52b may be removably coupled to the lower frame 50b so as to adjust the position of the lower bracket 52b relative to the lower frame 50b. In the example illustrated, the lower bracket 52b is an L-shaped bracket that includes a first member and a second member 58. The first member extends perpendicular to the second member 58b and is coupled to the upper frame 50a. The second member 58 extends from the first member 58a and is vertically aligned with the second member 56 of a respective upper bracket 52a.

Each mounting plate 54a is secured to the second member 56 of a respective upper bracket 52a and may include a front face 55a defining the opening 37a configured to receive the protrusion 34 of the collar 30a. In the example illustrated, two or more mounting plates 54a are secured to the second member 56 of a respective upper bracket 52a. In this way, the upper bracket 52a may be configured to support a plurality of vehicle components 12 at a time. In some forms, one mounting plate 54a may be secured to the second member 56 of one upper bracket 52a. The mounting plate 54a includes a rear face 55b having a groove 57 formed therein. The groove 57 is configured to receive portions of the protrusion 34 (e.g., the periphery 40, the outer portion 34b and maybe a portion of the inner portion 34a) when the vehicle component 12 is coupled to the upper bracket 52a of the part support 14.

The opening 37a includes an upper portion 36a and a lower portion 36b extending from the upper portion 36a. The upper portion 36a includes a diameter that is larger than a diameter of the periphery 40 of the protrusion 34. In this way, the protrusion 34 may be received in the opening 37a and the opening 37a may accommodate error in the vehicle component 12 initial positioning by the robot 22 as will be described in more detail below. In the example illustrated, the upper portion 36a has a circular shape. In some forms, the upper portion 36a may include a square shape, a rectangular shape, or any other suitable shape that is allowed to receive the periphery 40 of the protrusion 34. In the example illustrated, the lower portion 36b has a width that is smaller than the diameter of the upper portion 36a and has an arcuate shape that includes multiple turns (e.g., a zig-zag pattern). In this way, the protrusion 34 of the vehicle component 12 is inhibited from moving from the lower portion 36b to the upper portion 36a via arbitrary movement once the protrusion 34 is at a resting position within the lower portion 36b (i.e., the cylindrical inner portion 34a is at a lower end of the lower portion 36b abutting against the mounting plate 54a).

Each mounting plate 54b is secured to the second member 58 of a respective lower bracket 52b and may include a front face 65a defining the opening 37b configured to receive the protrusion 34 of the collar 30a. In the example illustrated, two or more mounting plates 54b are secured to the second member 58 of a respective lower bracket 52b. In this way, the lower bracket 52b may be configured to support a plurality of vehicle components 12 at a time. In some forms, one mounting plate 54b may be secured to the second member 58 of one lower bracket 52b. The mounting plate 54b includes a rear face 65b having a groove 67 formed therein. The groove 67 is configured to receive portions of the protrusion 34 (e.g., the periphery 40, the outer portion 34b and maybe a portion of the inner portion 34a) when the vehicle component 12 is coupled to the lower bracket 52b of the part support 14.

The opening 37b includes an upper portion 66a and a lower portion 66b extending from the upper portion 66a. The upper portion 66a includes a diameter that is larger than a diameter of the periphery 40 of the protrusion 34. In this way, the protrusion 34 may be received in the opening 37b and the opening 37b may accommodate error in the vehicle component 12 initial positioning by the robot 22 as will be described in more detail below. In the example illustrated, the upper portion 66a has a circular shape. In some forms, the upper portion 66a may include a square shape, a rectangular shape, or any other suitable shape that is allowed to receive the periphery 40 of the protrusion 34. In the example illustrated, the lower portion 66b has a width that is smaller than the diameter of the upper portion 66a and has a linear shape.

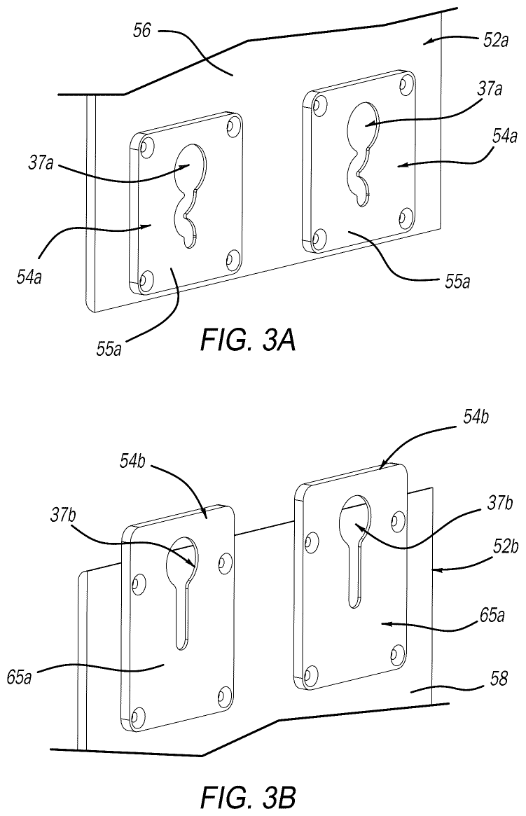

In some forms, as shown in FIG. 4C, an alternate mounting plate 51 may be included (i.e., coupled to the part support 14) instead of the mount plate 54a and/or the mounting plate 54b. The mounting plate 51 defines an opening 53 having an upper portion 53a and a lower portion 53b. The upper portion 53a has a diameter that is greater than a diameter of the lower portion 53b. In this way, the protrusion 34 may be received in the upper portion 53a of the opening 53 and moved to the lower power 53b of the opening 53 to secure the vehicle component 12 to the part support 14. The opening 53 may also include a resistant portion 53c between the upper portion 53a and the lower portion 53b. The resistant portion 53c has a width that is smaller than the diameter of the upper portion 53a and the diameter of the lower portion 53b. The mounting plate 51 may include resilient features 59 (e.g., spring retainers) that extend into resistant portion 53c to resist the protrusion 34 movement between the upper and lower portions 53a, 53b of the opening 53. In this way, the protrusion 34 of the vehicle component 12 is inhibited from moving from the lower portion 53b to the upper portion 53a via arbitrary movement once the protrusion 34 is at a resting position within the lower portion 53b. Stated differently, a predetermined force has to be applied to the vehicle component 12 to overcome a biasing force of the resilient features 59 and move the protrusion 34 between the upper and lower portions 53a, 53b of the opening 53.

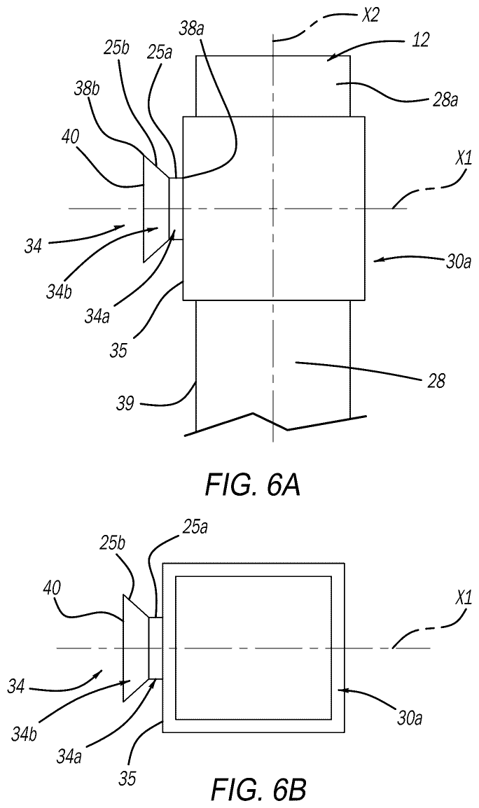

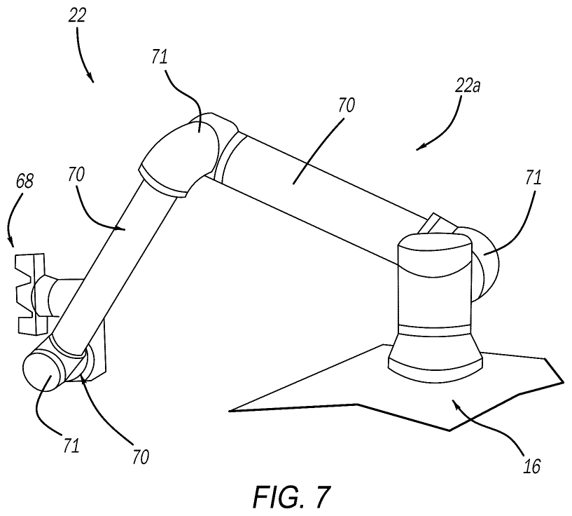

With reference to FIGS. 7 and 8, each robot 22 includes a robot arm 22a and a robotic gripper structure or apparatus 68. The robot arm 22a includes a plurality of segments 70 connected to each other at joints 71, thereby allowing the robot 22 to have multiple degrees of freedom. The robot arm 22a is also secured to the work surface 16 at a first end. In some variations, the robot arm 22a includes an optional adapter (not shown) that is adapted to be secured to the work surface 16. In some forms, the robot 22 is separate from the work surface 16 and is partially or fully autonomous and is configured to autonomously move to the part support 14 and/or work surface 16 as instructed by the controller 26. To autonomously move itself, the controller 26 is configured to control various movement systems of the robot 22 based on location data obtained from one or more sensors. In an example application, the movement systems may include propulsion systems, steering systems for controlling wheels, and the sensors for providing location data may include a GNSS sensor, an imaging sensor, a local position sensor, among others.

The robotic gripper structure 68 is secured to the robot arm 22a and is configured to grasp and move a respective vehicle component 12 from the part support 14 to the work surface 16. Stated differently, the robotic gripper structure 68 is configured to grasp and move the respective vehicle component 12 from the part support 14 to the work surface 16 without actuation of the robotic gripper structure 68. In this way, the unactuated robotic gripper structure 68 provides the benefit of less power consumption, increased robustness (e.g., fewer moving parts), and reduced maintenance.

The robotic gripper structure 68 includes opposed end plates 72a, 72b and a connecting plate 74. The opposed end plates 72a, 72b extend from respective ends of the connecting plate 74. In the example illustrated, the end plate 72a extends from the respective end of the connecting plate 74 a further distance than the end plate 72b. Each end plate 72a, 72b includes a plurality of mounting features 76 that are configured to engage a respective protrusion 44 of the vehicle component 12, thereby coupling (attaching) the vehicle component 12 to the robotic gripper structure 68. In the example illustrated, each mounting feature 76 is an arcuate slot including a portion having a shape that corresponds to a cylindrical shaped inner portion (not specifically shown) of the protrusion 44. In this way, the vehicle component 12 can be supported by the robotic gripper structure 68 (and the robot 22) when the cylindrical shaped inner portion is positioned at a resting position (i.e., the end) of the mounting feature 76. A tab 88 partially forms the mounting feature 76 and acts as a stop to inhibit the protrusion 44 positioned at the end from being removed the robotic gripper structure 68 without traversing the arcuate mounting feature 76. In the example illustrated, each end plate 72a, 72b includes two mounting features 76. It should be understood, in some configurations, each end plate 72a, 72b may include only one mounting feature 76 or more than two mounting features 76.

In the example illustrated, the end plate 72a includes optional channels 78 formed therein and leading into respective mounting features 76. Each channel 78 has a width that is greater than a width of the respective mounting feature 76. In this way, the robotic gripper structure 68 may accommodate for alignment error between the protrusion 44 and the mounting feature 76 when robot 22 goes to grasp the vehicle component 12 from the part support 14. The connecting plate 74 is coupled to one of the robot arms 22a via mechanical fasteners, for example, thereby securing the robotic gripper structure 68 to the robot 22.

With reference to FIG. 10, the controller 26 is in communication with the robot 22 and may monitor and control operations of the robot 22 based on data received. In one example, the controller 26 is in communication with the robot 22 using a wireless communication protocol (e.g., a Bluetooth®-type protocol, a cellular protocol, a wireless fidelity (Wi-Fi)-type protocol, a near-field communication (NFC) protocol, an ultra-wideband (UWB) protocol, among others).

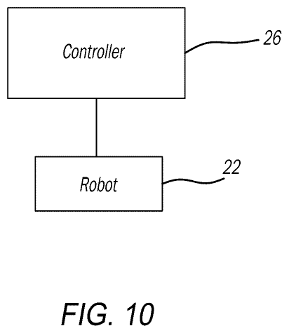

Referring to FIGS. 9A, 9B, and 11, an example control algorithm 100 for moving vehicle components 12 from the part support 14 to the work surface 16 using robot 22 is illustrated. The processing may begin once a plurality of vehicle components 12 have been positioned on the part support 14 as described above. At 104, the control algorithm, using the controller 26, instructs the robot 22 to move the robotic gripper structure 68 such that the end plate 72a of the robotic gripper structure 68 abuts against (or engages) the body 28 (and collars 30b) of the vehicle component 12 and the protrusions 44 of the vehicle component 12 are received in respective channels 78 of the end plate 72a (FIG. 9A). At 108, the control algorithm, using the controller 26, instructs the robot 22 to move the robotic gripper structure 68 such that the protrusions 44 of the vehicle component 12 is received within ends of the mounting features 76.

At 112, the control algorithm, using the controller 26, instructs the robot 22 to move the robotic gripper structure 68 in a pattern of the mounting features 76 (i.e., arcuate pattern) such that each protrusion 44 of the vehicle component 12 traverses the mounting feature 76 from one end of the mounting feature 76 to another end of the mounting feature 76. In this way, the vehicle component 12 is coupled to the robotic gripper structure 68 (and robot 22) by a hooking arrangement (FIG. 9). It should be understood that a tapered outer portion of the protrusion 44 guides the cylindrical inner portion into the mounting feature 76 such that the cylindrical inner portion is received in the mounting feature 76. A circular periphery of the protrusion 44 and the body 28 further acts to inhibit the cylindrical inner portion from being removed from the mounting feature 76 without traversing the arcuate pattern of the mounting feature 76. At 116, the control algorithm, using the controller 26, instructs the robot 22 to move the vehicle component 12 in an upward direction such that each protrusion 34 of the vehicle component 12 may be decoupled from a respective mounting plate 54a, 54b. In this way, the vehicle component 12 is separated from the part support 14 and is supported entirely by the robot 22.

At 120, the control algorithm, using the controller 26, instructs the robot 22 to move the vehicle component 12 to the work surface 16. It should be understood that the robot 22 may reposition or reorient the vehicle component 12 as it is being moved to the work surface 16. Stated differently, the vehicle component 12 may be picked up from the part support 14 in a vertical direction and may be placed on the work surface 16 in a horizontal direction. The unactuated robotic structure 68 is configured to allow for the repositioning/reorienting of the vehicle component 12 while still maintaining grip or securement with the vehicle component 12. At 124, the control algorithm, using the controller 26, instructs the robot 22 to move the robotic gripper structure 68 in the pattern of the mounting feature 76 such that each protrusion 44 of the vehicle component 12 traverses the mounting feature 76 and the channel 78 and is detached or separated from the vehicle component 12. In this way, the vehicle component 12 may be further processed automatically by another robot (not shown) in the automation process. The controller 26 may instruct the robot 22 to repeat the steps to move another vehicle component 12 from the part support 14 to the work surface 16.

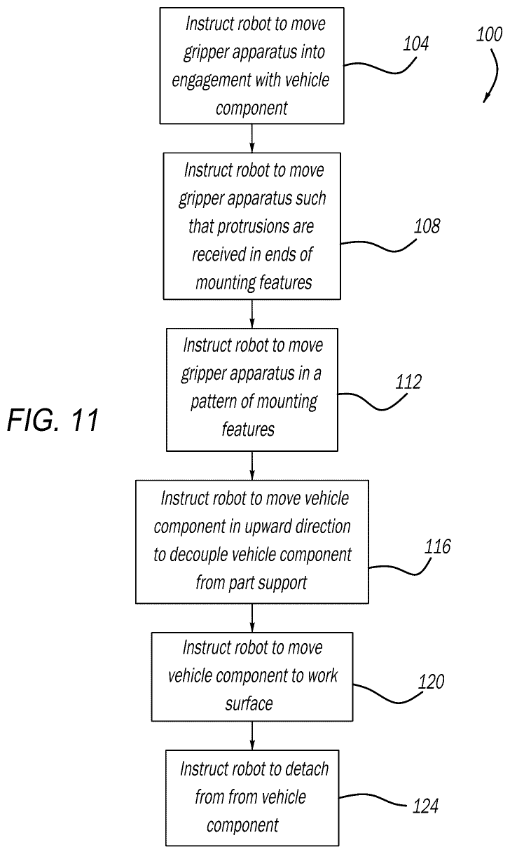

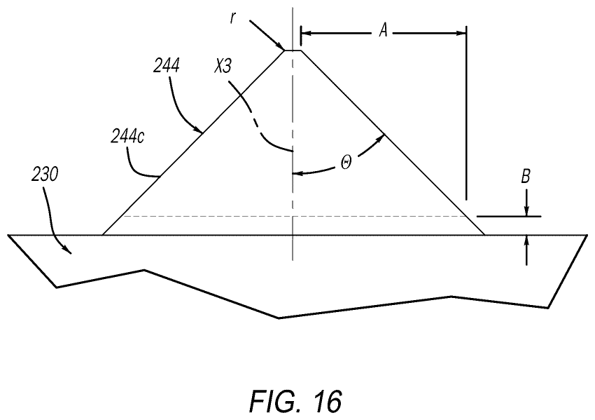

With reference to FIGS. 12-14, 15A, 15B, and 16-18, collars 230 and robot 222 are provided. The collars 230 and the robot 222 may be included in the system 10 above instead of the collars 30b and the robot 22, respectively. The structure and function of the collars 230 and the robot 222 may be identical or similar to the collars 30b and the robot 22, respectively, described above, apart from the exception noted below.

The collars 230 are secured to the body 28 between the collars 30a and are configured to be coupled to a respective robot 222. In this way, the robot 222 may pick-up the vehicle component 12 and move it from the part support 14 to the work surface 16, for example, for further processing. Each collar 230 has a shape that corresponds to the shape of the body 28. In the example illustrated, the collar 230 has a square shape that corresponds to the square shape of the body 28. The collar 230 also has end portions defining apertures. Mechanical fasteners (not shown) may extend through the apertures of the end portions, thereby securing (e.g., clamping) the collar 230 onto the body 28.

A pair of opposed protrusions 244 extend outward from respective sides of the collar 230 and are configured to extend into respective openings or mounting features 246 of the robot 222, thereby coupling the vehicle component 12 to the robot 222. Each protrusion 244 extends along an axis X3 that is perpendicular to the axis X2 of the body 28 and has a generally conical shape (the axis X3 is parallel to the axis X1). The protrusion 244 includes a distal end 244a, a proximal end 244b, and an outer surface 244c. The distal end 244a is pointed and the proximal end 244b extends from the respective side of the collar 230. The protrusion 244 is tapered from the proximal end 244b towards the distal end 244a. The outer surface 244c is angled and is configured to engage the robot 222 when the robot 222 picks up the vehicle component 12 as will be described in more detail below.

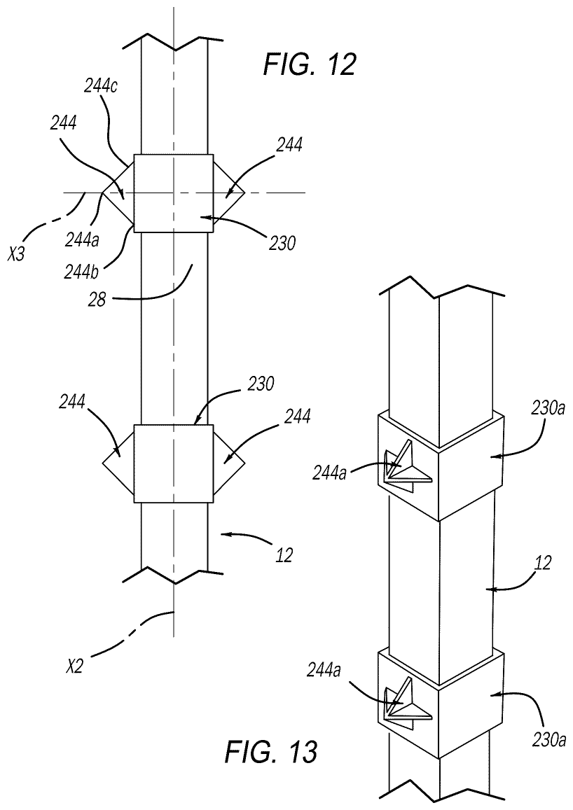

The protrusions 244 may be configured to accommodate up to a predetermined amount of misalignment between the protrusions 244 and a robotic gripper apparatus 268. In one example, the protrusion 244 may include the following parameters: the angle θ between the axis X3 and the outer surface 244c may be 45 degrees, a radius r of the bullnose may be one millimeter (mm), a gap B between surfaces may be one millimeter (mm), and a 10-millimeter (mm) misalignment range A. The protrusions 244 including these parameters may accommodate up to 10 millimeters of misalignment between the protrusions 244 and the robotic gripper apparatus 268. It should be understood that the angle θ between the axis X3 and the outer surface 244c may be adjusted to suit the coefficient of friction and the desired forces between the protrusions 244 and the robotic gripper apparatus 268. In some forms, as shown in FIG. 13, collars 230a including protrusions 244a may be provided. The protrusions 244a may be hollow. In this way, the protrusions 244a use less material and may facilitate manufacturing of the collars 230a (e.g., injection molding of the collar 230a).

Although the present disclosure shows the protrusions 244, 244a as being separate components from the body 28, in some forms, the body 28 may be manufactured (e.g., injection molding or 3D printing) to include the protrusions 244, 244a. In this way, the body 28 may be a unitary, monolithic component including the protrusions 244, 244a for connecting to the robot 222. It should also be understood that each collar 230, 230a (or body 28 of the vehicle component 12) may include one protrusion 244, 244a extending from one side and a flat opposing side instead of the pair of opposed protrusions 244, 244a.

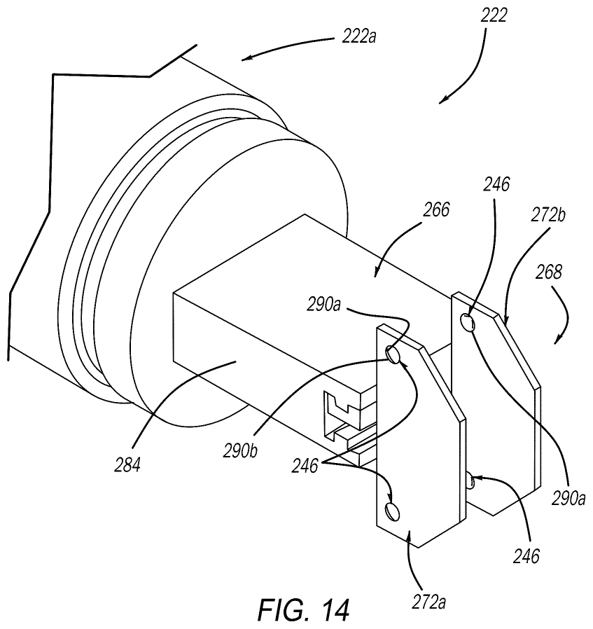

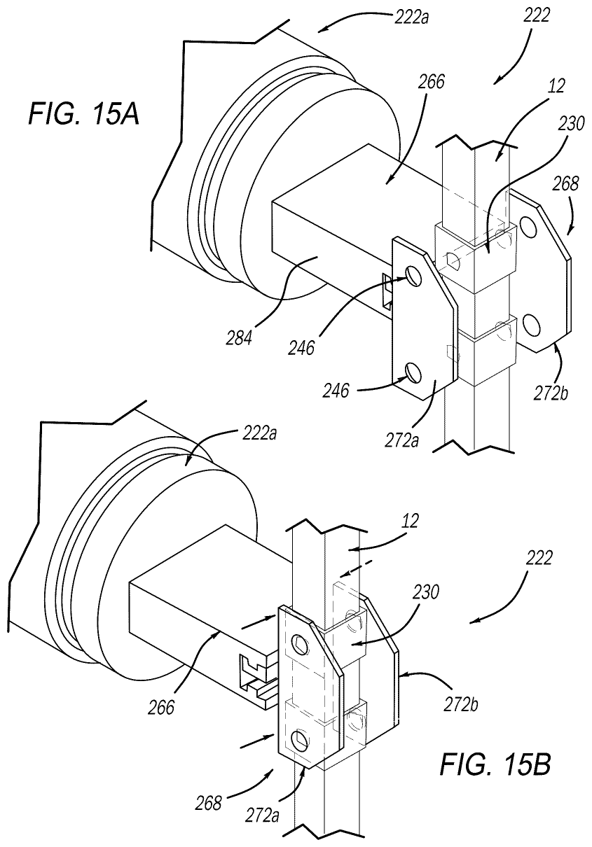

With reference to FIGS. 14, 15A, and 15B, the robot 222 includes a robot arm 222a and the robotic gripper structure 268. The structure and function of the robot arm 222a may be similar or identical to the robot arm 22a described above, and therefore, will not be described again in detail. The robotic gripper structure 268 is secured to the robot arm 222a and is configured to grasp and move a respective vehicle component 12 from the part support 14 to the work surface 16.

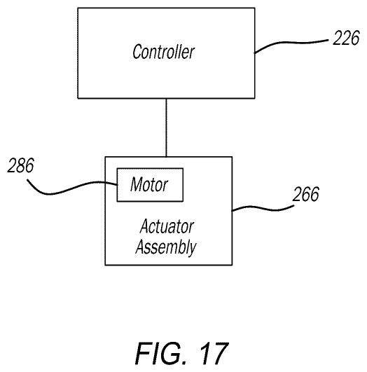

The robotic gripper structure or apparatus 268 includes an actuator assembly 266 and opposed end plates 272a, 272b. The actuator assembly 266 includes a body 284, a motor 286 (FIG. 17), and a pair of movable members or arms (not specifically shown). The body 284 is secured to the opposing second end of the robot arm 222a. The motor 286 is associated with the body 284 (e.g., disposed within the body 284) and is in electrical communication with a controller 226. The controller 226 may be in communication with the motor 286 via, for example, an internet, Wi-Fi, Bluetooth®, Zigbee®, power-line carrier communication (PLCC), or cellular connection or any other wired or wireless communication protocol. The motor 286 is operable between an OFF mode and an ON mode. In one form, the motor 286 may be an electric motor such as a brushless drive motor. Each arm is operatively connected to the motor 286 and is allowed to move in a transverse direction (i.e., transverse to a longitudinal direction of the body 28). For example, when the motor 286 is in the OFF mode, the arms are inhibited from moving in the transverse direction. When the motor 286 is in the ON mode, the arms are allowed to move in the transverse direction between an open state and a closed state.

Each end plate 272a, 272b is secured to a respective arm and includes a plurality of mounting features 246 that are configured to engage a respective protrusion 244, thereby coupling (attaching) the vehicle component 12 to the robotic gripper structure 268. In the example illustrated, each mounting feature 246 is an aperture extending through the plate 272a, 272b and including a portion 290a having a shape that corresponds to a portion of the protrusion 244. In this way, the vehicle component 12 can be supported by the robotic gripper structure 268 (and the robot 222) when the protrusions 244 extend at least partially through the mounting features 246. The shape of the portion 290a of the mounting features 246 of the example illustrated is conical or tapered. In some forms, the shape of the portion 290a of the mounting features 246 may be cylindrical, or any other suitable shape that allows the robotic gripper structure 268 to support the vehicle component 12. In the example where the portion 290a of the mounting features 246 are cylindrical, contact between the end plates 272a, 272b and the protrusions 244 may occur along edges as opposed to surfaces. The robotic gripper structure 268 of the present disclosure may accommodate for alignment error between the protrusion 244 and the mounting feature 246 when robot 222 goes to grasp the vehicle component 12 from the part support 14.

The mounting features 246 may also include another portion 290b that extends from the portion 290a. The portion 290b may be circular or cylindrical and may open through to a side of the end plate 272a, 272b. In the example illustrated, each end plate 272a, 272b includes two mounting features 246. It should be understood, in some configurations, each end plate 272a, 272b may include only one mounting feature 246 or more than two mounting features 246. In the example illustrated, the end plates 272a, 272b have a polygonal shape. In some forms, the end plates 272a, 272b may be circular or any other suitable shape including the mounting features.

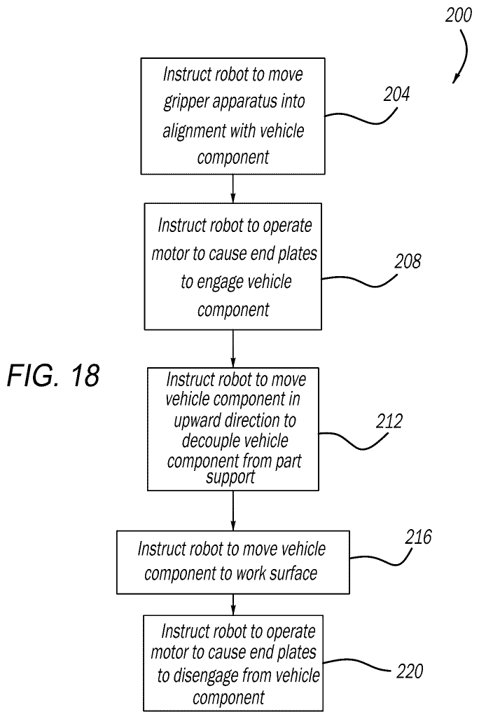

Referring to FIG. 18, an example control algorithm 200 for moving vehicle components 12 from the part support 14 to the work surface 16 using robot 222 is illustrated. The processing may begin once a plurality of vehicle components 12 have been positioned on the part support 14 as described above. At 204, the control algorithm, using the controller 226, instructs the robot 222 to move the robotic gripper structure 268 such that the mounting features 246 are substantially aligned with respective protrusions 244 of the vehicle component 12. At 208, the control algorithm, using the controller 226, operates the motor 286 to move the arms from the open state to the closed state, which, in turn, causes a portion of the outer surfaces 244c of the protrusions 244 to engage the mounting features 246. In this way, the robotic gripping apparatus 286 grips the vehicle component 12.

At 212, the control algorithm, using the controller 226, instructs the robot 222 to move the vehicle component 12 in an upward direction such that each protrusions 34 of the vehicle component 12 may be decoupled from a respective mounting plate 54a, 54b. In this way, the vehicle component 12 is separated from the part support 14 and is supported entirely by the robot 222.

At 216, the control algorithm, using the controller 226, instructs the robot 222 to move the vehicle component 12 to the work surface 16. It should be understood that the robot 222 may reposition or reorient the vehicle component 12 as it is being moved to the work surface 16. At 220, the control algorithm, using the controller 226, operates the motor 286 to move the arms from the closed state to the open state, which, in turn, causes the portion of the outer surfaces 244c of the protrusions 244 to disengage from the mounting features 246. In this way, the robotic gripping apparatus 286 is decoupled from the vehicle component 12. The vehicle component 12 may be further processed automatically by another robot (not shown) in the automation process. The controller 226 may instruct the robot 222 to repeat the steps to move another vehicle component 12 from the part support 14 to the work surface 16.

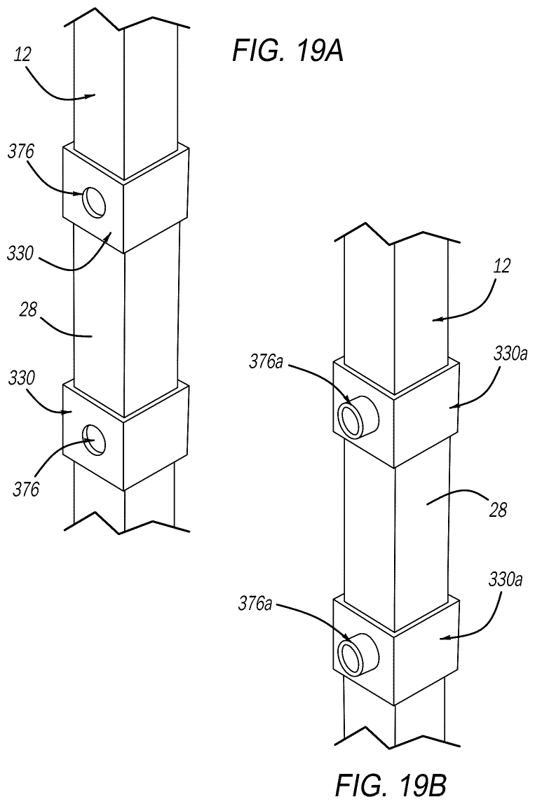

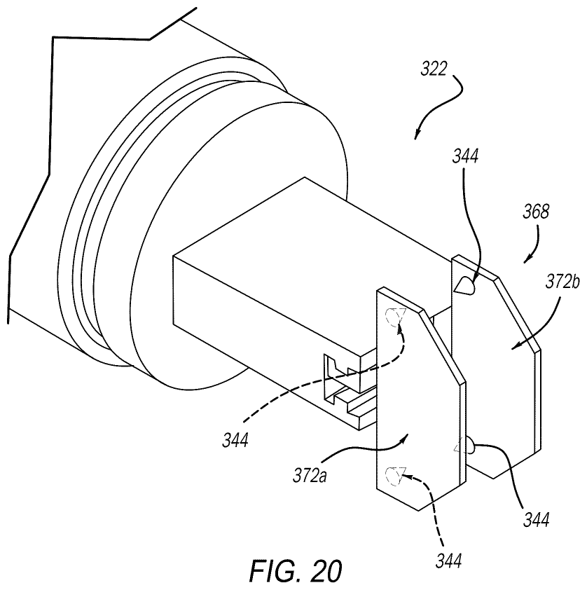

With reference to FIGS. 19A and 20, collars 330 and robot 322 are provided. The collars 330 and the robot 322 may be included in the system 10 above instead of the collars 30b and the robot 22, respectively. The structure and function of the collars 330 and the robot 322 may be identical or similar to the collars 30b and the robot 22, respectively, described above, apart from the exception noted below

The collars 330 are secured to the body 28 between the collars 30a and are configured to be coupled to a respective robot 322. In this way, the robot 322 may pick-up the vehicle component 12 and move it from the part support 14 to the work surface 16, for example, for further processing. A plurality of opposed mounting features 376 (only one shown in the figures) extend through respective sides of the collars 330. In the example illustrated, the mounting features 376 are apertures extending through the respective sides of the collars 330. In this way, a robotic gripping apparatus 368 is configured to engage the mounting features 376 of the vehicle component 12, thereby coupling (attaching) the vehicle component 12 to the robot 322.

In some forms, as shown in FIG. 19B, the mounting features 376a may be bosses extending from respective sides of the of the collars 330a. The bosses may be hollow, cylindrical bosses that are configured to engage the robotic gripping apparatus 368. The bosses may also include a bottom surface that inhibits the robotic gripping apparatus 368 from contacting electrical components (e.g., wires) inside the body 28.

The robot 322 includes a robot arm and the robotic gripper structure 368. The structure and function of the robot arm may be similar or identical to the robot arm 22a described above, and therefore, will not be described again in detail. The robotic gripper structure 368 is secured to the robot arm and is configured to grasp and move a respective vehicle component 12 from the part support 14 to the work surface 16.

The robotic gripper structure 368 includes an actuator assembly and opposed end plates 372a, 372b. The structure and function of the actuator assembly may be similar or identical to the actuator assembly 266 described above, and therefore, will not be described again in detail. Each end plate 372a, 372b is secured to the actuator assembly and includes a plurality of protrusions 344 extending therefrom. The protrusions 344 are spaced apart from each other and extend inward from the plate 372a, 272b and are configured to extend into respective mounting features 376 of the collars 330, thereby coupling the vehicle component 12 to the robot 322. The structure and function of the protrusions 344 may be similar or identical to the protrusions 244 described above, and therefore, will not be described again in detail.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components (e.g., op amp circuit integrator as part of the heat flux data module) that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A system for handling electrical components of a vehicle, the system comprising:
a body configured to house the electrical components and defining a longitudinal axis;
at least one first protrusion extending outwardly from the body along an axis, the at least one first protrusion including a cylindrical shaped inner portion at a proximal end of the at least one first protrusion and a tapered outer portion near a distal end of the at least one first protrusion;
a robot configured to move the body; and
a gripper structure secured to the robot and including at least one first mounting feature, the at least one first mounting feature includes a portion comprising a shape that corresponds to the cylindrical shaped inner portion of the at least one first protrusion such that the gripper structure is configured to be removably coupled to the body.

2. The system of claim 1, wherein the at least one first protrusion includes a circular periphery at the distal end, and wherein a diameter of the circular periphery is greater than a diameter of the cylindrical portion.

3. The system of claim 1, wherein the at least one first protrusion includes a circular periphery at the distal end, and wherein the at least one first protrusion tapers from the circular periphery towards the cylindrical portion.

4. The system of claim 1, wherein the at least one first mounting feature is an aperture, and wherein the at least one first protrusion extends through the aperture.

5. The system of claim 4, wherein the aperture is arcuate.

6. The system of claim 1, wherein the at least one first protrusion has a funnel shape.

7. The system of claim 1, further comprising:
a second protrusion extending outwardly from the body; and
a third protrusion spaced apart from the second protrusion and extending outwardly from the body.

8. The system of claim 7, further comprising:
a first mounting plate configured to be secured to a stationary body and including a second mounting feature configured to receive the second protrusion, the second mounting feature having a first upper portion and a first lower portion, the first upper portion having a diameter than is greater than a width of the first lower portion; and
a second mounting plate spaced apart from the first mounting plate and configured to be secured to the stationary body, the second mounting plate including a third mounting feature configured to receive the third protrusion, the third mounting feature having a second upper portion and a second lower portion, the second upper portion having a diameter than is greater than a width of the second lower portion.

9. The system of claim 8, wherein a shape of the first lower portion is different than a shape of the second lower portion.

10. The system of claim 8, further comprising:
a controller configured to instruct the robot to move the body between a first position in which the body is decoupled from the stationary body and a second position in which the body is coupled to the stationary body,
wherein, when the body is in the first position, the second and third protrusions are received in the first and second upper portions of the first and second mounting plates, respectively, and when the body is in the second position, the second and third protrusions are received in the first and second lower portions of the first and second mounting plates, respectively.

11. The system of claim 1, wherein the axis of the at least one first protrusion extends perpendicular to the longitudinal axis of the body.

12. A system for handling electrical components of a vehicle, the system comprising:
a body configured to house the electrical components and defining a longitudinal axis;
a pair of opposed first protrusions extending outwardly from the body along an axis that is perpendicular to the longitudinal axis of the body, each first protrusion of the pair of opposed first protrusions including a proximal end, a distal end, and an outer surface, the outer surface is tapered from the proximal end towards the distal end;
a robot configured to move the body; and
a gripper structure secured to the robot and including a pair of opposed first mounting features, each first mounting feature of the pair of opposed first mounting features includes a portion comprising a shape that corresponds to a portion of the outer surface of a respective first protrusion of the pair of opposed first protrusions such that the gripper structure is removably coupled to the body.

13. The system of claim 12, further comprising:
a second protrusion extending outwardly from the body; and
a third protrusion spaced apart from the second protrusion and extending outwardly from the body, the pair of opposed first protrusions located between the second protrusion and the third protrusion.

14. The system of claim 13, further comprising:
a first mounting plate configured to be secured to a stationary body and including a second mounting feature configured to receive the second protrusion, the second mounting feature having a first upper portion and a first lower portion, the first upper portion having a diameter than is greater than a width of the first lower portion; and
a second mounting plate spaced apart from the first mounting plate and configured to be secured to the stationary body, the second mounting plate including a third mounting feature configured to receive the third protrusion, the third mounting feature having a second upper portion and a second lower portion, the second upper portion having a diameter than is greater than a width of the second lower portion,

15. The system of claim 14, further comprising:
a controller configured to instruct the robot to move the body between a first position in which the body is decoupled from the stationary body and a second position in which the body is coupled to the stationary body,
wherein, when the body is in the first position, the second and third protrusions are received in the first and second upper portions of the first and second mounting plates, respectively, and when the body is in the second position, the second and third protrusions are received in the first and second lower portions of the first and second mounting plates, respectively.

16. The system of claim 12, wherein the gripping structure includes a pair of opposed plates, and wherein each plate of the pair of opposed plates includes a respective first mounting feature of the pair of opposed first mounting features.

17. The system of claim 16, wherein the pair of opposed first mounting features are apertures formed in the pair of opposed plates.

18. A system for handling electrical components of a vehicle, the system comprising:
a body configured to house the electrical components and defining a longitudinal axis;
a robot configured to move the body; and
a gripper structure secured to the robot and including a pair of opposed protrusions, each protrusion of the pair of opposed protrusions extending from the body along an axis that is perpendicular to the longitudinal axis of the body, each protrusion of the pair of opposed protrusions including a proximal end, a distal end, and an outer surface, the outer surface is tapered from the proximal end towards the distal end; and
a pair of opposed mounting features associated with the body and configured to receive the pair of opposed protrusions such that the gripper structure is removably coupled to the body.

19. The system of claim 18, wherein the pair of opposed mounting features are apertures formed in the body.

20. The system of claim 18, wherein the gripping structure includes a pair of opposed plates, and wherein each plate of the pair of opposed plates includes a respective protrusion of the pair of opposed protrusions.
